(19) United States
(12) Patent Application Publication
(10) Pub. No.: US 2025/0392024 A1
(43) Pub. Date: Dec. 25, 2025

(54) SYSTEM AND METHOD FOR SELECTIVE ACCESS TO BATTERY CELL TERMINALS

(71) Applicant: Kyma Batteries LLC, Dallas, TX (US)

(72) Inventor: Travis Cournoyer, Hawthorne, CA (US)

(21) Appl. No.: 18/753,985

(22) Filed: Jun. 25, 2024

(51) Int. Cl. H01M 50/591; B08B 3/04; H01M 10/48; H01M 50/107

(52) U.S. Cl. CPC H01M 50/591; B08B 3/04; H01M 10/48; H01M 50/107

(57) ABSTRACT

A system includes an apparatus including a cap configured to fit over an end of a battery cell having a terminal. The cap forms an opening arranged to be over the terminal. The apparatus further includes a protective element for the opening that provides selective access to the terminal and a securing feature for removably securing the cap to the battery cell.

### INTRODUCTION

The present disclosure is directed to a system and method for fitting a cap over an end of a battery, and more particularly to a system and method for isolating positive and negative terminals of batteries from one another.

### SUMMARY

Battery cells may be stored or processed together. Battery cells have positive and negative terminals and may require special handling to prevent accidental discharge or other harm or degradation. The terminals may be on a same side or surface of the battery cell, and in some embodiments, a height differential between the positive and negative terminals may be minimal. An electrical path may be formed between the terminals when the side of the battery having the terminals contacts a surface, such as a side of another battery cell. The formed electrical path may drain and potentially damage the battery cell, which may unnecessarily reduce a life of the battery cell or cause an accelerated discharge that could be a concern for safety of nearby operators or equipment.

In some embodiments, an apparatus comprises a cap configured to fit over an end of a battery cell having a terminal. The cap forms an opening arranged to be over the terminal. The apparatus further comprises a protective element for the opening (e.g., to mask the opening) and provide selective access to the terminal and a securing feature for removably securing the cap to the battery cell.

In some embodiments, the protective element comprises a self-sealing material disposed in the opening configured to form a watertight seal after being punctured by a probe.

In some embodiments, the protective element comprises a flip cover. In some embodiments, the flip cover comprises a hinge. In some embodiments, the flip cover further comprises a lever configured to rotate the flip cover about the hinge to provide selective access to the battery cell.

In some embodiments, the battery cell comprises a button terminal and a rim terminal. The opening is a first opening configured to allow access to the button terminal. The cap forms a second opening configured to allow access to the rim terminal.

In some embodiments, the securing feature comprises a magnet configured to create a magnetic force to removably secure the cap to the battery cell.

In some embodiments, a system comprises a battery cell. The battery cell comprises a button terminal and a rim terminal. The system further comprises a cap assembly configured to fit over an end of a battery cell having the button terminal. The cap assembly comprises a protective element to mask an opening formed in the cap assembly and provide selective access to the battery cell. The system further comprises a measuring tool having probes configured to probe the button and rim terminals.

In some embodiments, a method comprises retrieving a battery cell having a terminal. The method further comprises placing a cap assembly over an end of the battery cell having the terminal. The cap assembly forms an opening arranged over the terminal and comprises a protective element for the opening that provides selective access to the terminal. The method further comprises cleaning the battery cell having the cap assembly using an aqueous or organic cleaning solution. The method further comprises moving the protective element to access the battery cell. The method further comprises using a measuring tool to access the terminal and take a measurement.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 is a schematic illustration of a cap assembly and a battery cell, in accordance with embodiments of the disclosure;

FIG. 2A is a top view of the cap assembly of FIG. 1, in accordance with embodiments of the disclosure;

FIG. 2B is a side sectional view of the cap assembly of FIG. 2A, in accordance with embodiments of the disclosure;

FIG. 2C is a schematic sectional view of the cap assembly of FIG. 1, in accordance with embodiments of the disclosure;

FIG. 3A is a side sectional view of a cap assembly, in accordance with embodiments of the disclosure;

FIG. 3B is a schematic view of a measuring tool used with the cap assembly of FIG. 3A, in accordance with embodiments of the disclosure;

FIG. 4A is a top view of a cap assembly, in accordance with embodiments of the disclosure;

FIG. 4B is a side sectional view of the cap assembly of FIG. 4A, in accordance with embodiments of the disclosure;

FIG. 5 is a flowchart of an illustrative process for using a cap assembly during processing of a battery cell, in accordance with embodiments of the disclosure;

FIG. 6 is a schematic view of a measuring tool used with a cap assembly, in accordance with embodiments of the disclosure; and

FIG. 7 is a schematic view of a plurality of cap assemblies on battery cells in a clean tank, in accordance with embodiments of the disclosure.

### DETAILED DESCRIPTION

Multiple battery cells may be processed together to reduce a processing or manufacturing timeline while also removing hazards. In some situations, the battery cells have previously been used and may need to be cleaned before they can be used again. Individually cleaning each battery cell may not be practical, and batch cleaning may be preferred. In some embodiments, the present disclosure is directed to methods and systems for using a cap assembly during processing of a battery cell. In some embodiments, the cap assembly electrically isolates the positive terminal from the negative terminal. In some embodiments, the cap assembly includes a protective element that facilitates selective access the terminals, such as for evaluating, testing, or using the battery. In some implementations, an automated system may manipulate the protective element to selectively access the terminals.

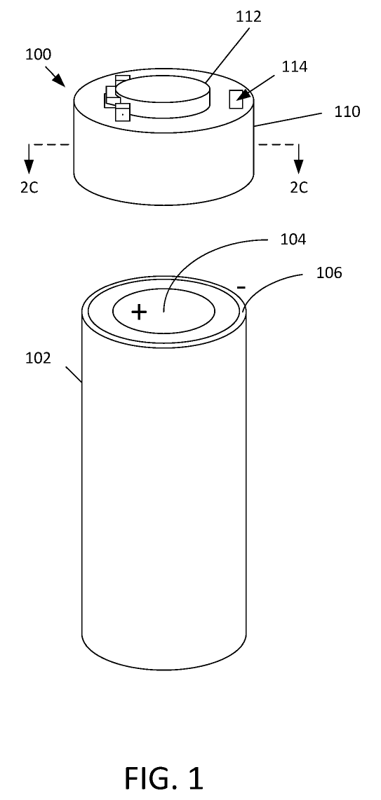

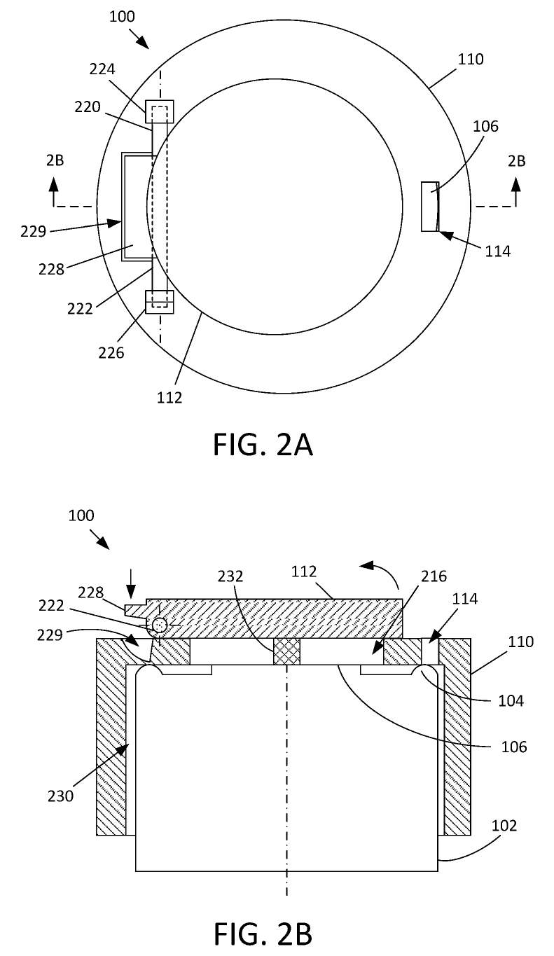

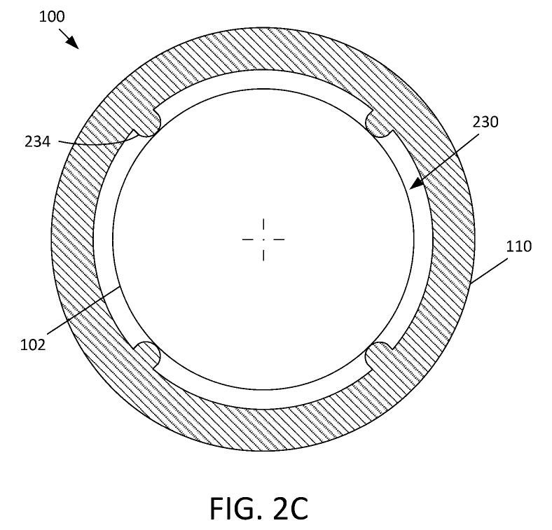

FIG. 1 is a schematic illustration of a cap assembly 100 and a battery cell 102, in accordance with embodiments of the disclosure. As illustrated, the cap assembly 100 includes a cap body 110 and a protective element, such as a flip cover 112. The cap body 110 comprises a top and a sidewall extending away from the top (e.g., shown as downward on the page). The cap body 110 forms a terminal opening (e.g., terminal opening 216, discussed below in relation to FIG. 2B) and a second access opening 114 in the top.

The cap assembly 100 is configured to fit over an end of a battery cell 102 having a terminal (e.g., button terminal 104 and/or a rim terminal 106). In some embodiments, the top of the cap body 110 is positioned over the end of the battery cell 102 and the sidewall surrounds a portion of an outer side of the battery cell, such as discussed in relation in FIG. 2B. The battery cell 102 comprises a button terminal 104 and a rim terminal 106. In some embodiments, the button terminal 104 is a positive terminal and the rim terminal 106 is a negative terminal. In the embodiment depicted in FIG. 1, the second access opening 114 is arranged to be over the rim terminal 106 such that the second access opening 114 provides a probe tip or connector access to the rim terminal 106. In some embodiments, the second access opening 114 is arranged to be positioned over any of the button or rim terminals 104, 106 when the cap assembly 100 is fitted over the battery cell 102.

The flip cover 112 is movable to provide selective access to the battery cell 102. As shown, the flip cover is in a closed position. In some embodiments, the flip cover 112 provides selective access to the terminal opening, such as by rotating about a hinge axis, to an open position. In some implementations, the hinge axis is parallel to a top surface of the cap body 110. In some embodiments, the battery cell 102 is a cylindrical cell having a centerline and the hinge axis is perpendicular to the centerline. In some embodiments, the flip cover 112 provides selective access to the button terminal 104.

The cap assembly 100 may be used to prevent electrically coupling the button and rim terminals 104, 106 to each other, such as by forming an electrical path between the two. The cap assembly 100 comprises a non-conductive material. In some embodiments, the cap assembly 100 is used to prevent electrically coupling any of the button or rim terminals 104, 106 to other surfaces, such as to another battery cell 102. Preventing the electrical coupling may reduce defectivity or reduce yield loss by preventing draining of battery cells, or may decrease manufacturing costs associated with conventional battery manufacturing methods by allowing batch processing of battery cells 102. For example, the cap assembly 100 may be used in combination with the methods below to substantially prevent short circuiting of battery cells 102.

FIG. 2A is a top view of the cap assembly 100 of FIG. 1, in accordance with embodiments of the disclosure.

The flip cover 112 includes a hinge 220 or hinge mechanism to rotate the flip cover 112. The hinge 220 includes a hinge pin 222, hinge pin holder 224, and a biased hinge pin holder 226. The hinge pin 222 is coupled to the flip cover 112. In some embodiments, the hinge pin 222 is disposed within, or extends through, a hinge opening formed by the flip cover 112. The hinge pin holder 224 and biased hinge pin holder 226 are coupled to the hinge pin 222 at opposite ends of the hinge pin 222. The hinge pin holder 224 and biased hinge pin holder 226 are any of coupled to, attached to, fixed to, or integrally formed with the top of the cap body 110. The biased hinge pin holder 226 exerts a force or moment on any of the hinge pin 222 or flip cover 112 to secure or bias the flip cover 112 in the closed position.

In some embodiments, the hinge pin 222 is at least partially disposed within an opening formed by any one of the hinge pin holder 224 and biased hinge pin holder 226. In some embodiments, the hinge pin 222 is fixed to any of the hinge pin holder 224 and biased hinge pin holder 226. In some embodiments, the hinge pin 222 rotates within any of the hinge pin holder 224 and biased hinge pin holder 226.

In some embodiments, the biased hinge pin holder 226 includes any of a compliant mechanism, elastic member, or spring that stores mechanical energy. In some implementations, as the flip cover 112 rotates away from the cap body 110, the compliant mechanism is compressed and stores mechanical energy. When the flip cover 112 is released, the compliant mechanism exerts the stored mechanical energy (e.g., a force) on the hinge pin 222 or flip cover 112 and moves the flip cover 112 towards the cap body 110. Thus, the compliant mechanism is “biased” to move the flip cover 112 towards the cap body 110 and retain the flip cover 112 in the closed position.

The flip cover 112 further includes a lever 228 configured to rotate the flip cover 112 about the hinge 220 to provide selective access to the battery cell. In some embodiments, the lever is positioned on an end or side of the flip cover 112. As a force acts on the lever 228 (e.g., pushing the lever 228 towards the cap body 110), the flip cover 112 rotates about the hinge axis and an opposite end of the flip cover 112 moves away from the cap body 110. The cap body 110 forms a tab cavity 229 or opening in a side facing the flip cover 112 (e.g., a top face as shown on the page). The tab cavity 229 provides space for the lever 228 to enter as the flip cover 112 rotates.

Some embodiments do not include the biased hinge pin holder 226. In some implementations, two hinge pin holders 224 are used to secure the hinge pin 222 and a securing feature (e.g., magnet 232, discussed below in relation to FIG. 2B) secures the flip cover 112 to the battery cell (e.g., battery cell 102 in FIGS. 1, 2B, and 2C).

FIG. 2B is a side sectional view of the cap assembly 100 of FIG. 2A, in accordance with embodiments of the disclosure.

The top of the cap body 110 forms a terminal opening 216, which is a through hole in the top extending from an upper surface of the top to a lower surface of the top. The second access opening 114 is also a through hole in the top. The sidewall of the cap body 110 forms a battery cavity 230 to receive an end of the battery cell 102. An inner surface(s) of the sidewall faces the battery cell 102. In some embodiments, the battery cavity 230 is at least partly defined by the lower surface of the top and the inner surface(s) of the sidewall. In some embodiments, a gap or space is formed between the battery cell 102 and the surfaces of the cap body 110. In some implementations, the gap forms a passage to allow a cleaning solution to flow though to clean the battery cell 102. In some examples, the cleaning solution is an aqueous or organic cleaning solution.

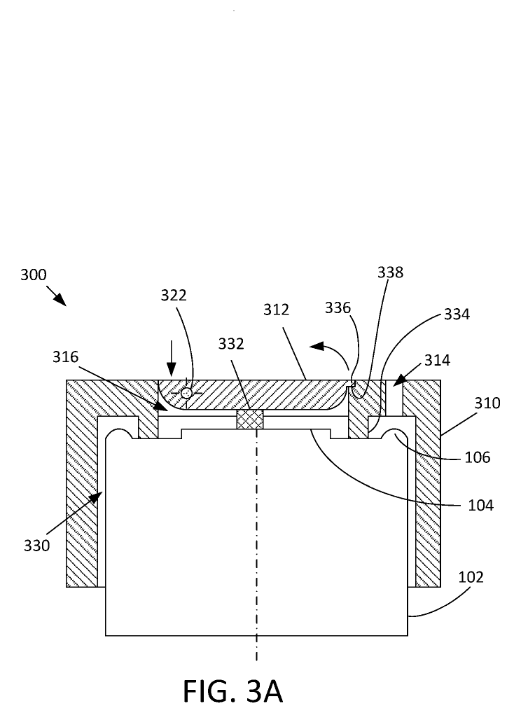

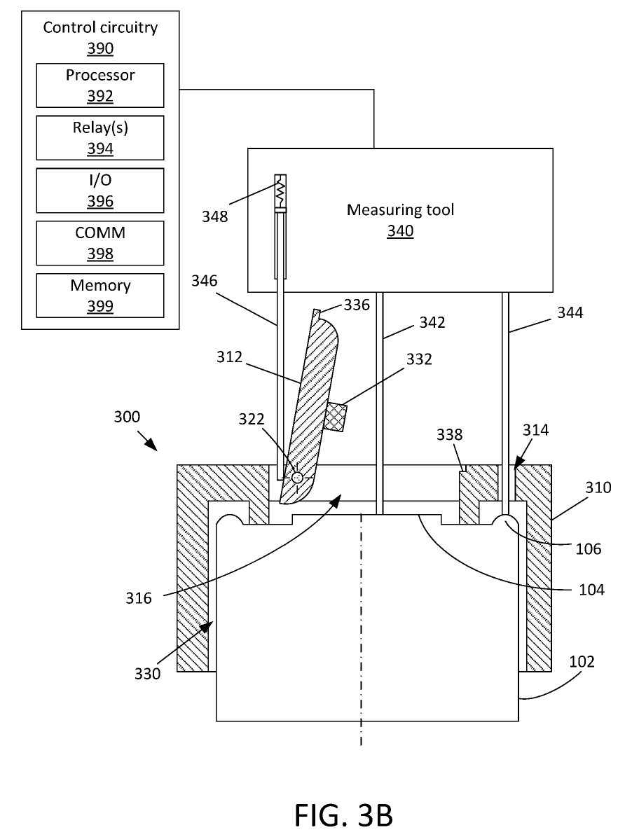

A securing feature, such as a magnet 232, is coupled to the flip cover 112. The magnet 232 creates a magnetic force to removably secure the flip cover 112 to the end of the battery cell 102 when the flip cover 112 is in or near the closed position. In some embodiments, the magnet 232 is disposed in between the flip cover 112 and the battery cell 102. As a force is exerted on the lever 228 (e.g., downward as shown on the page), a moment is created that rotates the flip cover 112 about the hinge axis (e.g., counter-clockwise as shown on the page) and moves the lever 228 into the tab cavity 229. The flip cover 112 rotates when the force exerted exceeds the magnetic force created by the magnet 232. In some embodiments, the flip cover 112 does not have the tab 228 and a force is put on a top surface of the flip cover 112, such as discussed below in relation to FIGS. 3A and 3B. In some implementations, the flip cover 112 does not include the tab cavity 229.

In some embodiments, the magnet 232 is formed within the flip cover 112. In some implementations, the magnet 232 is encapsulated within the flip cover 112. In some implementations, at least one side of the magnet 232 is exposed and may contact the battery cell 102. In some embodiments, the magnet 232 removably secures the cap assembly 100 to the battery cell 102.

In some embodiments, respective magnets (e.g., magnet 232) may be coupled to the flip cover 112 and the cap body 110. The respective magnets create a magnetic force to removably secure the flip cover 112 to the cap body 110.

FIG. 2C is a schematic sectional view of the cap assembly 100 of FIG. 1, in accordance with embodiments of the disclosure. In particular, FIG. 2C shows a cross-section of the cap body 110 in a plane that is normal or perpendicular to an axis of the battery cell 102.

The cap assembly 100 includes a securing feature, such as standoffs 234. The standoffs 234 are any of coupled to, attached to, fixed to, or integrally formed with inner surfaces(s) of the sidewall of the cap body 110. In some embodiments, the standoffs 234 contact the battery cell 102 to removably secure the cap assembly 100 to the battery cell 102. In some embodiments, at least one of the standoffs 234 do not contact the battery cell 102. In some embodiments, the standoffs 234 form passageways for a cleaning solution to flow.

In some embodiments, the standoffs 234 comprise a same material as the cap body 110. In some embodiments, the standoffs 234 comprise a grippy or squishy material to help secure the cap assembly 100 to the battery cell 102. In some embodiments, the inner surfaces(s) of the sidewall of the cap body 110 includes the grippy or squishy material. In some implementations, the cap body does not include the standoffs 234. In some examples, the grippy or squishy material is positioned or patterned throughout the inner surfaces(s) of the sidewall of the cap body 110 to form a gap or space between the battery cell 102 and the surfaces of the cap body 110.

In the embodiments depicted in FIGS. 1-2C, the battery cell 102 has a cylindrical shape having an outer wall. The inner side of the sidewall of the cap body 110 has a cylindrical shape, and the standoffs 234 extend out from the sidewall. The flip cover 112 has a circular shape that is larger than a circular shape of the terminal opening 216. In some embodiments, any of these may have a different shape, such as a polygonal, irregular polygonal, frustoconical, freeform or unstructured, or conic shape.

FIG. 3A is a side sectional view of a cap assembly 300, in accordance with embodiments of the disclosure. The cap assembly 300 is shown fitted over an end of the battery cell 102.

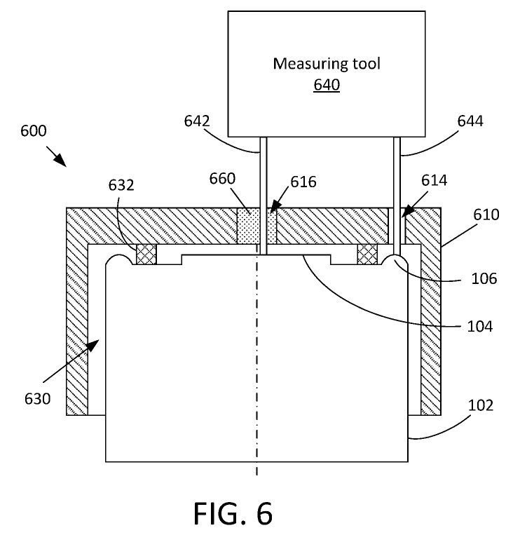

The cap assembly 300 includes a cap body 310, flip cover 312, and a magnet 332. The cap body 310 forms a second access opening 314 and battery cavity 330. The cap body 310 includes standoffs 334 extending outward (e.g., downward as shown on the page) and towards the battery cell 102. The standoffs 334 provide a gap between a lower surface of a top of the cap body 310 and the battery cell 102. In some embodiments, the gaps form passageways. In some embodiments, at least one of the standoffs 334 comprises a magnet (e.g., magnet 232 in FIG. 2B or magnet 632, discussed below in relation to FIG. 6). In some implementations, the magnet is used to removably secure the cap assembly 300 to the battery cell 102.

The flip cover 312 is disposed in a terminal opening 316 formed by the cap body 310 and rotates around a hinge pin 322, which is coupled to the cap body 310. An upper surface of the flip cover 312 is flush, even, or substantially planar with an upper surface of the cap body 310. The planar configuration provides an embodiment where the cap assembly 300 does not have a protrusion from its upper surface, which may prevent the flip cover 312 from snagging on another item and unintentionally opening. The flip cover 312 further comprises a lip 336 or edge at an end opposite of the hinge pin 322. The lip 336 rests on a respective ledge 338 formed by the cap body 310 and may prevent the flip cover 312 from over rotating past the closed position and into the terminal opening 316. In some embodiments, the lip 336 may be used to position the magnet 332 at a predetermined distance from the battery cell 102 (e.g., not contacting the battery cell 102).

FIG. 3B is a schematic view of a measuring tool 340 used with the cap assembly 300 of FIG. 3A, in accordance with embodiments of the disclosure.

The measuring tool 340 includes a first probe 342, a second probe 344, an access arm 346, and control circuitry 390. In some embodiments, the control circuitry 390 uses the first and second probes 342, 344 to run diagnostics or evaluations on the battery cell 102. In some implementations, the first and second probes 342, 344 are used for any of measuring voltage, internal impedance, or resistance of components, or cycling the battery cell 102. In some implementations, the first probe 342 contacts one of the button terminal 104 or the rim terminal 106 and the second probe 344 contacts the other of the terminals 104, 106. The access arm 346 is used to engage and rotate the flip cover 312 to allow one of the first or second probes 342, 344 to access the button terminal 104. In the embodiment depicted in FIG. 3B, the access arm 346 has moved the flip cover 312 to the open position and the first probe 342 has moved through the terminal opening 316 and contacts the button terminal 104. As the access arm 346 contacts and rotates the flip cover 312, it retracts into the measuring tool 340 to allow the first and second probes 342, 344 to move closer to the battery cell 102. The second probe 344 has moved through the second access opening 314 and contacts the rim terminal 106. When the measuring tool 340 is moved away from the cap assembly 300, a biasing element 348 exerts a force on and protracts or extends the access arm 346. The biasing element 348 includes any of a compliant mechanism, elastic member, or spring that stores mechanical energy.

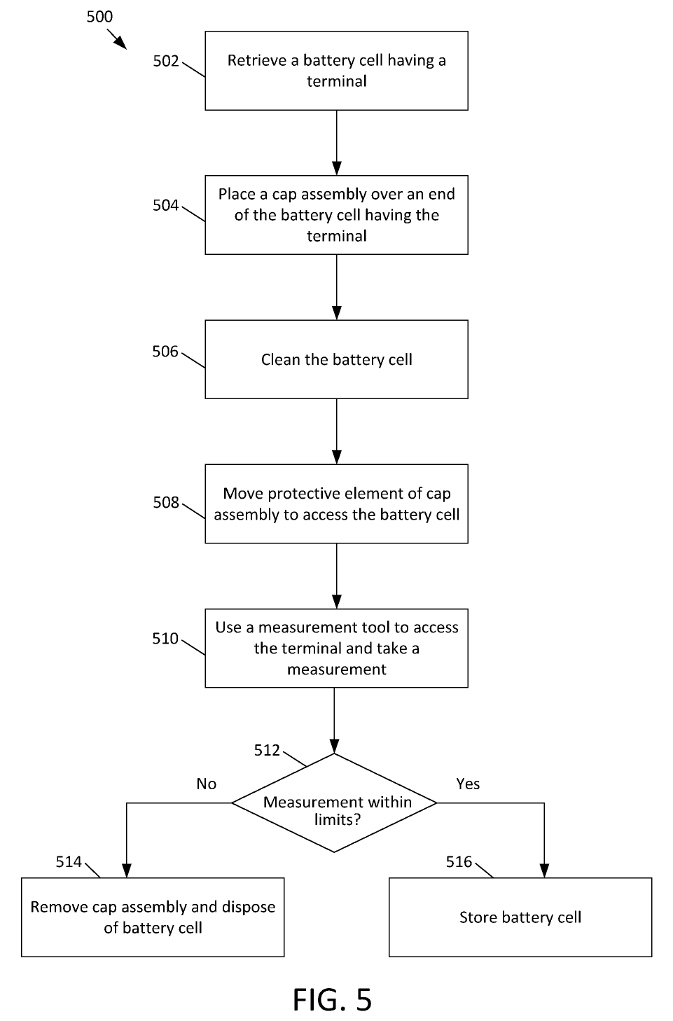

Illustrative control circuitry 390 includes processor 392, one or more relays 394 (hereinafter referred to as relay(s) 394), input/output 396 (hereinafter referred to as I/O 396), communication hardware 398 (hereinafter referred to as COMM 398), and memory 399. Control circuitry 390 may include hardware, software, or both, implemented on one or more modules configured to provide control of the measuring tool 340 (or, e.g., measuring tool 640 in FIG. 6). In some embodiments, processor 392 includes one or more microprocessors, microcontrollers, digital signal processors, programmable logic devices, field-programmable gate arrays (FPGAs), application-specific integrated circuits (ASICs), or any suitable combination thereof. In some embodiments, processor 392 is distributed across more than one processor or processing units. In some embodiments, control circuitry 390 executes instructions stored in memory (e.g., non-transitory computer readable media) for controlling the measuring tool 340. In some embodiments, memory 399 is an electronic storage device that is part of control circuitry 390. For example, memory 399 may be configured to store electronic data, computer instructions, applications, firmware, or any other suitable information. In some embodiments, memory 399 includes random-access memory, read-only memory, hard drives, optical drives, solid state devices, or any other suitable memory storage devices, or any combination thereof. For example, memory 399 may be used to launch a start-up routine, diagnostic routine, or power-management routine. In some embodiments, memory 399 includes non-transitory computer-readable media that includes computer executable instructions for evaluating battery cells (e.g., process 500, discussed below in relation to FIG. 5).

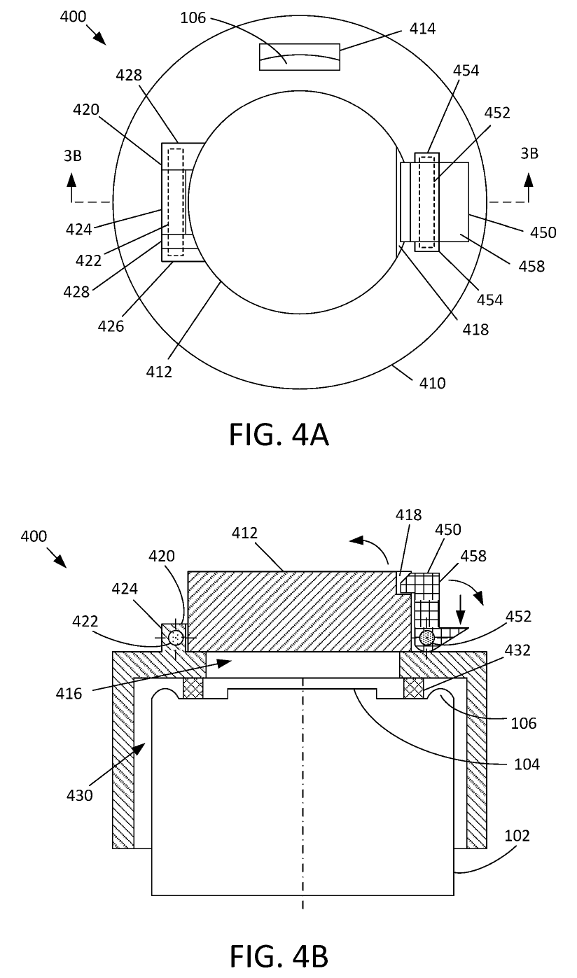

FIG. 4A is a top view of a cap assembly 400, in accordance with embodiments of the disclosure. FIG. 4B is a side sectional view of the cap assembly 400 of FIG. 4A, in accordance with embodiments of the disclosure. FIGS. 4A and 4B are herein described together for brevity.

The cap assembly 400 is shown fitted over an end of the battery cell 102. The cap assembly 400 includes a cap body 410, flip cover 412, latch mechanism 450, and magnets 432. The cap body 410 forms a second access opening 414, a terminal opening 416, and a battery cavity 430. The flip cover 412 is coupled to the cap body 410 through a pivot joint 420. The pivot joint 420 comprises rotation arms 428, a hinge pin holder 424, a hinge pin 422, and a biasing element 426. The rotation arms 428 are any of coupled to, attached to, fixed to, or integrally formed with a side or outer sidewall of the flip cover 412. The hinge pin holder 424 is any of coupled to, attached to, fixed to, or integrally formed with a top of the cap body 410. When the flip cover 412 rotates to an open position, the rotation arms 428 move in relation to the hinge pin holder 424. The rotation arms 428 move about or with the hinge pin 422.

The latch mechanism 450 includes a latch arm 458, latch pin 452, and latch pin holders 454. The latch pin holders 454 are any of coupled to, attached to, fixed to, or integrally formed with a top of the cap body 410. The latch pin 452 is coupled at each end to a latch pin holder 454, and travels through the latch arm 458. The flip cover 412 forms a latch catch 418, which is a ledge to catch the latch arm 458. The latch mechanism 450 is used to open the flip cover 412 by rotating the latch arm 458 with or about the latch pin 452 and disengaging the latch catch 418. The biasing element 426 rotates the flip cover 412 to the open position.

In some embodiments, the latch mechanism 450 includes a biasing element (e.g., biasing element 348, 426 in FIGS. 3 and 4) to bias the latch arm 458 towards the flip cover 412.

The magnets 432 are coupled to the cap body 410 and positioned between a top of the cap body 410 and the battery cell 102. The magnets 432 removably secure the cap assembly 400 to the battery cell 102.

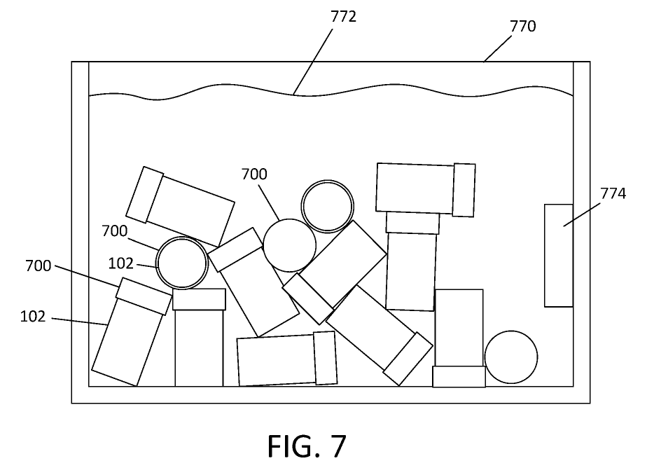

FIG. 5 is a flowchart of an illustrative process 500 for using a cap assembly (e.g., cap assembly 100, 300, 400 in FIGS. 1-4 or cap assembly 600, 700, discussed below in relation to FIGS. 6 and 7) during processing of a battery cell (e.g., battery cell 102 in FIGS. 1-4 and 6-7), in accordance with embodiments of the disclosure.

The process 500 starts at operation 502 with control circuitry (e.g., control circuitry 390 in FIG. 3) retrieving a battery cell having a terminal (e.g., button terminal 104 or rim terminal 106 in FIGS. 1-4 and 6-7).

The process 500 continues to operation 504 with the control circuitry placing a cap assembly over an end of the battery cell having the terminal, such as described above with respect to FIG. 1. In some embodiments, operation 504 is optional. In some implementations, the battery cell already has a cap assembly on them.

The process 500 continues to operation 506 with the control circuitry cleaning the battery cell, such as discussed below in relation to FIG. 7. In some embodiments, operation 506 is optional. In some implementations, the battery cell is already clean or does not need to be cleaned.

The process 500 continues to operation 508 with the control circuitry moving a protective element (e.g., flip cover 112, 312, 412 in FIGS. 1-4 or self-sealing material 660, discussed below in relation to FIG. 6) of the cap assembly to access the battery cell, such as discussed with respect to FIGS. 3B and 6. In some embodiments, the protective element is moved to access a terminal of the battery cell. In some embodiments, an access arm (e.g., access arm 346) or a probe (first or second probes 342, 344 or 644, 642 in FIGS. 3 and 6) of a measuring tool (e.g., measuring tool 340 in FIG. 3B or measuring tool 640, discussed below in FIG. 6) moves the protective element.

The process 500 continues to operation 510 with the control circuitry using the measuring tool to access the terminal and take a measurement, such as described in relation to FIG. 3B.

The process 500 continues to operation 512 with the control circuitry determining whether the measurement is within limits. If the determination is no, the process 500 continues to operation 514 with the control circuitry removing the cap assembly and disposing of battery cell. If the determination is yes, the process 500 continues to operation 516 with the control circuitry storing the battery cell.

In some embodiments, at least one of operations 502-514 are optional or omitted. In some embodiments, the operations 502-514 are performed in a different order. In some embodiments, additional operations are performed.

FIG. 6 is a schematic view of a measuring tool 640 used with a cap assembly 600, in accordance with embodiments of the disclosure. The cap assembly 600 is shown fitted over an end of the battery cell 102.

The cap assembly 600 includes a cap body 610 and magnets 632. The cap body 610 forms a terminal opening 616, second access opening 614, and battery cavity 630. The magnets 632 couple to the cap body 610, extend into the battery cavity 630, and removably couple the cap assembly 600 to the battery 102. The cap assembly 600 includes a protective element, such as a self-sealing material 660 disposed in the terminal opening 616, to provide selective access to the button terminal 104.

The measuring tool 640 includes a first probe 642 and a second probe 644. In order to take measurements, the first probe 642 pierces or penetrates the self-sealing material 660 to access the button terminal 104. The second probe 644 moves through the access opening 614 to access the rim terminal 106. In some embodiments, the self-sealing material 660 rearranges itself to at least reduce the size of a puncture hole in the material. In some embodiments, the self-sealing material 660 comprises any of wax, a polymer, a foam, or an elastomer.

FIG. 7 is a schematic view of a plurality of cap assemblies 700 on battery cells 102 in a clean tank 770, in accordance with embodiments of the disclosure. The clean tank is filled with a cleaning solution 772. In some embodiments, the cleaning solution comprises any of an aqueous or organic cleaning solution.

The battery cells 102 with the cap assemblies 700 installed are thrown or placed in the clean tank 770 (e.g., using a wire basket). An agitator 774 encourages or urges the cleaning solution 772 to flow against surfaces of the battery cells 102 and in between the battery cells 102 and cap assemblies 700 (e.g., through passageways as discussed in relation to FIGS. 2 and 3A). In some embodiments, the agitator 774 comprises any of a paddle, propellor, or ultrasonic agitator. Special jigs or fixtures are not needed to arrange to battery cells 102 since the cap assemblies 700 protect the battery cells 102 from short circuiting.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. An apparatus, comprising:
a cap configured to fit over an end of a battery cell having a terminal, wherein the cap forms an opening to be arranged over the terminal;
a protective element for the opening that provides selective access to the terminal; and
a securing feature for removably securing the cap to the end of the battery cell.

2. The apparatus of claim 1, wherein the protective element comprises a self-sealing material disposed in the opening and capable of being punctured by a probe.

3. The apparatus of claim 1, wherein the protective element comprises a flip cover.

4. The apparatus of claim 3, wherein the flip cover comprises a hinge.

5. The apparatus of claim 4, wherein the flip cover further comprises a lever configured to rotate the flip cover about the hinge to provide selective access to the battery cell.

6. The apparatus of claim 1, wherein:
the battery cell comprises a button terminal and a rim terminal;
the opening is a first opening configured to allow access to the button terminal; and
the cap forms a second opening configured to allow access to the rim terminal.

7. The apparatus of claim 1, wherein the securing feature comprises a magnet configured to create a magnetic force to removably secure the cap to the end of the battery cell.

8. The apparatus of claim 1, wherein:
the cap comprises a top, a sidewall extending away from the top, and a standoff;
the opening is a through hole in the top;
an inner side of the sidewall and an inner side of the top form a cavity configured to receive the end of the battery cell; and
the standoff is configured to provide a gap between the inner sides of the sidewall and top and the battery cell.

9. The apparatus of claim 8, wherein the gap forms a passage to allow an aqueous or organic cleaning solution to flow though to clean the battery cell.

10. A system, comprising:
a battery cell comprising a button terminal and a rim terminal;
a cap assembly configured to fit over an end of the battery cell having the button terminal, the cap assembly comprising a protective element for an opening formed in the cap assembly to provide selective access to the button terminal; and
a measuring tool having probes configured to probe the button and rim terminals.

11. The system of claim 10, wherein the protective element comprises a self-sealing material disposed in the opening and capable of being punctured by one of the probes of the measuring tool.

12. The system of claim 10, wherein the protective element comprises a flip cover configured to rotate about a hinge to provide selective access for one of the probes of the measuring tool to the button terminal.

13. The system of claim 12, wherein the measuring tool comprises an access arm to rotate the flip cover about the hinge.

14. The system of claim 10, wherein:
the opening is a first opening configured to allow access for a first one of the probes of the measuring tool to the button terminal; and
the cap assembly forms a second opening configured to allow access for a second one of the probes of the measuring tool to the rim terminal.

15. The system of claim 10, wherein the cap assembly further comprises a magnet to create a magnetic force to removably secure the cap assembly to the end of the battery cell.

16. A method comprising:
placing a cap assembly over an end of a battery cell having a terminal, wherein the cap assembly forms an opening arranged over the terminal and comprises a protective element for the opening that provides selective access to the terminal;
cleaning the battery cell having the cap assembly using an aqueous or organic cleaning solution;
moving the protective element to access the battery cell; and
using a measuring tool to access the terminal and take a measurement.

17. The method of claim 16, wherein:
the protective element is a self-sealing material disposed in the opening; and
moving the protective element to access the battery cell comprises puncturing the self-sealing material with a probe of the measuring tool.

18. The method of claim 16, wherein:
the protective element is a flip cover disposed in or over the opening; and
moving the protective element to access the battery cell comprises rotating the flip cover about an axis.

19. The method of claim 16, further comprising moving the protective element to block access to the terminal after taking measurement with the measuring tool.

20. The method of claim 16, wherein cleaning the battery cell comprises placing the battery cell having the cap assembly in a tank filled with aqueous or organic cleaning solution and other battery cells having cap assemblies.
